(19) United States
(12) Patent Application Publication
(10) Pub. No.: US 2012/0099575 A1
(43) Pub. Date: Apr. 26, 2012

(54) APPARATUS AND METHOD FOR COMPLEX COMMUNICATION

(75) Inventors: Se Han KIM, Daejeon (KR); Cheol Sig Pyo, Daejeon (KR); In Hwan Lee, Daejeon (KR); Hoyong Kang, Daejeon (KR); Tae Joon Park, Daejeon (KR); Wun-Cheol Jeong, Daejeon (KR); Chang Sub Shin, Daejeon (KR); Kyohoon Son, Daejeon (KR)

(73) Assignee: Electronics and Telecommunications Research Institute, Daejeon (KR)

(21) Appl. No.: 13/282,060

(22) Filed: Oct. 26, 2011

(30) Foreign Application Priority Data
Oct. 26, 2010 (KR) 10-2010-0104779
Jun. 30, 2011 (KR) 10-2011-0064856

(51) Int. Cl. H04W 92/00; H04L 12/66

(52) U.S. Cl. 370/338; 370/352

(57) ABSTRACT

A complex communication apparatus transmits/receives voice information with other complex communication apparatuses through a set voice channel. The complex communication apparatus broadcasts a signaling packet expressing a destination identifier representing a desired communication type of one-to-one communication, group communication, and broadcast communication with other complex communication apparatuses and information of the set voice channel and performs voice communication with a complex communication apparatus corresponding to a destination identifier of other complex communication apparatuses, having received the signaling packet.

### CROSS-REFERENCE TO RELATED APPLICATION

This application claims priority to and the benefit of Korean Patent Application Nos. 10-2010-0104779 and 10-2011-0064856 filed in the Korean Intellectual Property Office on Oct. 26, 2010 and Jun. 30, 2011, the entire contents of which are incorporated herein by reference.

### BACKGROUND OF THE INVENTION

(a) Field of the Invention

The present invention relates to a method and apparatus for complex communication.

(b) Description of the Related Art

A radio is a device that can perform communication with a desired person or a group of tens of persons. In general, a radio using for voice communication includes an amateur radio (CB, FRS) and a simple radio (GMRS, LMR), and these radios can perform communication in a communication radius from 500 m to maximum 10 km with an output of 0.5-3W.

Nowadays, a radio can randomly set a group within a communication radius or perform only a simple channel change in consideration of a voice channel quality. Further, as networks are variously extended, various services can be provided, however a radio is used for only voice communication of a broadcast method of 1:N and thus a utility value of the radio is low.

### SUMMARY OF THE INVENTION

The present invention has been made in an effort to provide a method and apparatus for complex communication having advantages of performing setting of a group and a change of a voice channel and providing various functions in addition to voice communication.

An exemplary embodiment of the present invention provides a method of communicating in a complex communication apparatus. The method includes setting one voice channel of available voice channels for voice communication; broadcasting a signaling packet expressing a destination identifier representing a type of voice communication and information of the one voice channel; and performing voice communication with at least one radio communication apparatus corresponding to a destination identifier of a plurality of other complex communication apparatuses, having received the signaling packet.

The broadcasting of a signaling packet may include broadcasting the signaling packet through a physical channel of a wireless personal area network.

The method may further include sensing peripheral information and transmitting the peripheral information to the outside through the physical channel.

The type of the voice communication may include at least one-to-one communication, group communication, and broadcast communication.

The destination identifier may be included in a destination identifier field of the signaling packet, and a most significant bit of the destination identifier field may represent one of the one-to-one communication, the group communication, and the broadcast communication.

The method may further include displaying that the one voice channel is being used in a voice channel table in which information of available voice channels is stored.

The method may further include increasing a channel use count of the one voice channel by 1 in the voice channel table.

Another embodiment of the present invention provides a method of communicating in a complex communication apparatus. The method includes receiving a signaling packet including a destination identifier field representing a destination identifier and a voice channel field representing voice channel information from other complex communication apparatuses; setting, when the destination identifier corresponds with an identifier in which the complex communication apparatus has or when the destination identifier represents broadcast communication, a voice channel according to the voice channel information; and performing voice communication with the other complex communication apparatuses through the voice channel.

The receiving of a signaling packet may include receiving the signaling packet through a physical channel of a wireless personal area network.

The method may further include sensing peripheral information and transmitting the peripheral information to the outside through the physical channel.

An identifier in which the complex communication apparatus has may include an identifier of the complex communication apparatus and an identifier of a group including the complex communication apparatus, and the destination identifier field may represent an identifier of the apparatus or an identifier of the group by a most significant bit of the destination identifier field.

The setting of a voice channel may include displaying that the set voice channel is being used in a voice channel table in which information of available voice channels is stored; and increasing a channel use count of the set voice channel by 1.

Yet another embodiment of the present invention provides a complex communication apparatus that performs voice communication. The complex communication apparatus includes a wireless personal area network (WPAN) communication unit that transmits/receives a packet through a physical channel of a WPAN; a bi-directional radio communication unit that transmits/receives voice information through a set voice channel; and a controller that sets a voice channel to perform voice communication and that expresses a destination identifier representing a type of the voice communication and information of the set voice channel in a signaling packet and that broadcasts the signaling packet through the WPAN communication unit, when starting voice communication.

The complex communication apparatus may further include a sensor unit that senses peripheral information or that receives sensing information from another sensor and that transmits the sensing information to the outside through the physical channel.

The controller may set a voice channel corresponding to the voice channel information according to a destination identifier of the signaling packet, when receiving a signaling packet from other complex communication apparatuses through the WPAN communication unit.

The destination identifier may represent one of an identifier of the complex communication apparatus, a group identifier, and broadcast communication.

### BRIEF DESCRIPTION OF THE DRAWINGS

FIG. 1 is a diagram illustrating a configuration of a complex communication apparatus according to an exemplary embodiment of the present invention.

FIGS. 2 and 3 are each diagrams illustrating an example of a communication radius of a WPAN communication unit and a bi-directional radio communication unit that are shown in FIG. 1.

FIG. 4 is a table illustrating an example of a voice channel table according to an exemplary embodiment of the present invention.

FIG. 5 is a message flow diagram illustrating a one-to-one communication method of a complex communication apparatus according to an exemplary embodiment of the present invention.

FIG. 6 is a message flow diagram illustrating a group communication method of a complex communication apparatus according to an exemplary embodiment of the present invention.

FIG. 7 is a message flow diagram illustrating a broadcast communication method of a complex communication apparatus according to an exemplary embodiment of the present invention.

FIG. 8 is a block diagram illustrating a signaling packet structure according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the specification and claims, unless explicitly described to the contrary, the word “comprise” and variations such as “comprises” or “comprising”, will be understood to imply the inclusion of stated elements but not the exclusion of any other elements.

Hereinafter, a method and apparatus for complex communication according to an exemplary embodiment of the present invention will be described in detail with reference to the drawings.

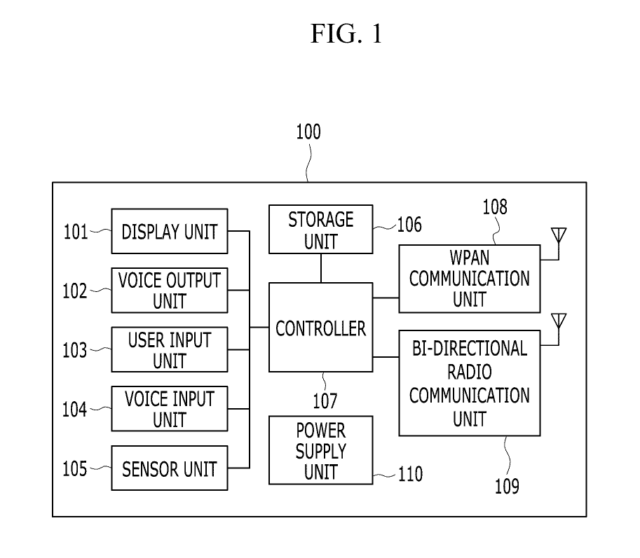

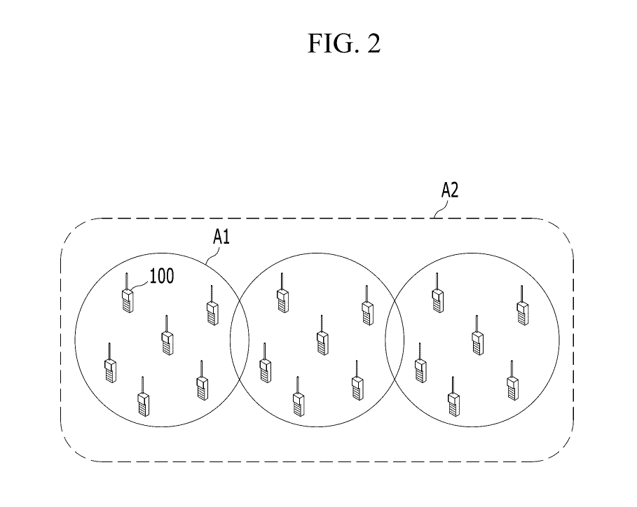

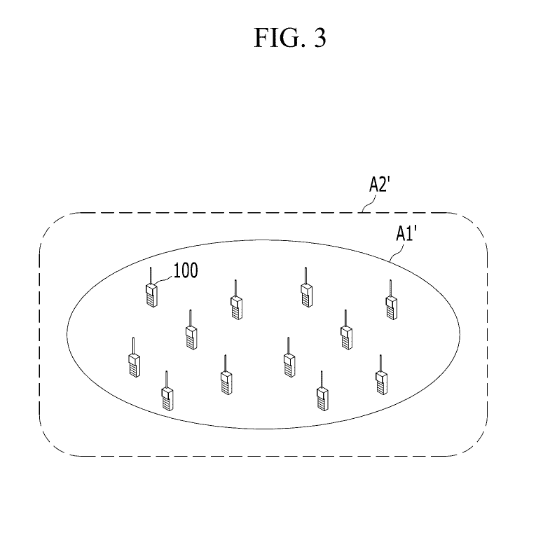

FIG. 1 is a diagram illustrating a configuration of a complex communication apparatus according to an exemplary embodiment of the present invention, and FIGS. 2 and 3 are each diagrams illustrating an example of a communication radius of a wireless personal area network (WPAN) communication unit and a bi-directional radio communication unit that are shown in FIG. 1.

Referring to FIG. 1, a complex communication apparatus 100 generally performs a function of a radio and performs packet communication with other complex communication apparatuses using a physical channel of a WPAN as a signaling channel, thereby performing setting, change, and release of a communication group, and setting, change, and release of a channel.

Further, the complex communication apparatus 100 performs a function of sensing object or peripheral information and transmits the sensed information to the outside through a signaling channel. The complex communication apparatus 100 is connected to another sensor to receive information in which the another sensor senses and transmits the information to the outside through the signaling channel.

The complex communication apparatus 100 includes a display unit 101, a voice output unit 102, a user input unit 103, a voice input unit 104, a sensor unit 105, a storage unit 106, a controller 107, a WPAN communication unit 108, a bi-directional radio communication unit 109, and a power supply unit 110.

The display unit 101 visually displays an operating state or a power residual quantity state of the complex communication apparatus 100 to a user.

The voice output unit 102 outputs a sound that receives from another complex communication apparatus. The voice output unit 102 may be a speaker.

The user input unit 103 receives a command for setting and controlling the complex communication apparatus 100 from a user, a command for setting, change, and release of a group for voice communication, and a command for setting, change, and release of a voice channel and transfers the commands to the controller 107. The user input unit 103 may use a button key, a touch screen, a keyboard, or a mouse.

The voice input unit 104 receives a voice from a user to transfer the voice to the controller 107. The voice input unit 104 may be a microphone.

The sensor unit 105 includes at least one sensor for sensing object or peripheral information and transfers the sensed information to the controller 107. Further, the sensor unit 105 is connected to peripheral another sensor to transfer information that is sensed by the another sensor to the controller 107. In this way, in the complex communication apparatus 100, the sensor unit 105 performs a sensing function and may form a ubiquitous sensor network (USN) and a wireless sensor network (WSN), and can provide a service that can be provided in the network.

The storage unit 106 is interlocked with the controller 107 and is used for storing various information. For example, the storage unit 106 may store voice information that receives from other complex communication apparatuses or voice information of a user, and sensed information. Further, the storage unit 106 stores information that is related to voice communication such as voice channel information or a communication type.

The controller 107 controls the display unit 101, the voice output unit 102, the user input unit 103, the voice input unit 104, the sensor unit 105, the storage unit 106, the WPAN communication unit 108, the bi-directional radio communication unit 109, and the power supply unit 110.

The controller 107 controls the complex communication apparatus 100 according to a command that is input from the user input unit 103.

The controller 107 sets, changes, and releases a group for group voice communication according to a communication radius of the WPAN communication unit 108 and the bi-directional radio communication unit 109. The controller 107 generates a signaling packet for notifying other complex communication apparatuses of setting, change and release of a group, and transmits the signaling packet through the WPAN communication unit 108.

The controller 107 sets, changes, and releases a voice channel for voice communication. The controller 107 generates a signaling packet for notifying other complex communication apparatuses of setting, change, and release of a voice channel and transmits the signaling packet through the WPAN communication unit 108.

Further, the controller 107 generates a packet for transmitting sensed information and transmits the packet through the WPAN communication unit 108.

The WPAN communication unit 108 uses a physical channel of the WPAN as a signaling channel and transmits/receives the packet. A communication radius of the WPAN communication unit 108 may be smaller than or equal to a communication radius of the bi-directional radio communication unit 109. A specification of the WPAN communication unit 108 may follow a format of IEEE 802.15.4. That is, the complex communication apparatus 100 can generally perform a function of a radio and perform packet communication through the WPAN communication unit 108.

The bi-directional radio communication unit 109 transmits a user's voice or receives a voice from another complex communication apparatus by the control of the controller 107 to transfer the voice to the controller 107. The bi-directional radio communication unit 109 has a communication radius from 500 m to maximum 10 km.

For example, a communication radius of the WPAN communication unit 108 and the bi-directional radio communication unit 109 may be set, as shown in FIG. 2 or 3. That is, a communication radius A1 of the bi-directional radio communication unit 109 is larger than a communication radius A2 of the WPAN communication unit 108 and may be similar to communication radiuses A1′ and A2′ of the WPAN communication unit 108 and the bi-directional radio communication unit 109 according to a performance and peripheral environment of the WPAN communication unit 108.

The power supply unit 110 is a device that supplies power to the complex communication apparatus 100 and may include a primary battery or a rechargeable battery. The power supply unit 110 may supply power using various self charge methods according to an application and may be connected to an external electronic device to charge power.

The complex communication apparatus 100 can be applied to an application field in which several persons to tens of persons communicate together, for example, communication in group leisure such as group cycling, group climbing, and group fishing, communication of a platoon unit of an army, and communication in an industry spot.

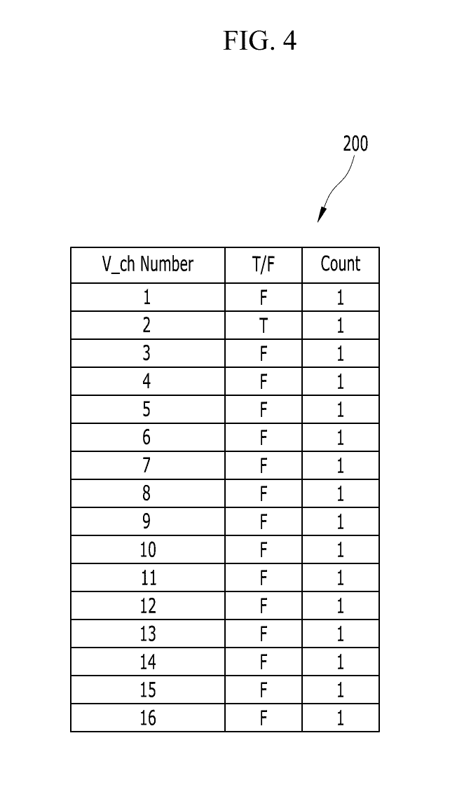

FIG. 4 is a table illustrating an example of a voice channel table according to an exemplary embodiment of the present invention.

Referring to FIG. 4, a voice channel table 200 is stored at the storage unit (106 of FIG. 1) of the complex communication apparatus 100.

The voice channel table 200 stores a number V_ch number of a voice channel that can be used for voice communication, and stores a channel use count and channel use T/F of available voice channels.

The channel use count represents a use count of a corresponding voice channel, an initial value thereof is set to 1, and the channel use count increases by 1 according to a use count.

The channel use T/F represents whether a corresponding voice channel is presently being used, an initial value thereof is set to “F”, and if a corresponding voice channel is being used, the channel use is set to “T”, and if a corresponding voice channel is not being used, the channel use is set to “F”.

The controller 107 sets a voice channel for voice communication with reference to the voice channel table 200. That is, in order to evenly use entire available voice channels with reference to a channel use count of the voice channel table 200 while avoiding a presently using voice channel with reference to channel use T/F of the voice channel table 200, the controller 107 selects a voice channel for voice communication having a small channel use count.

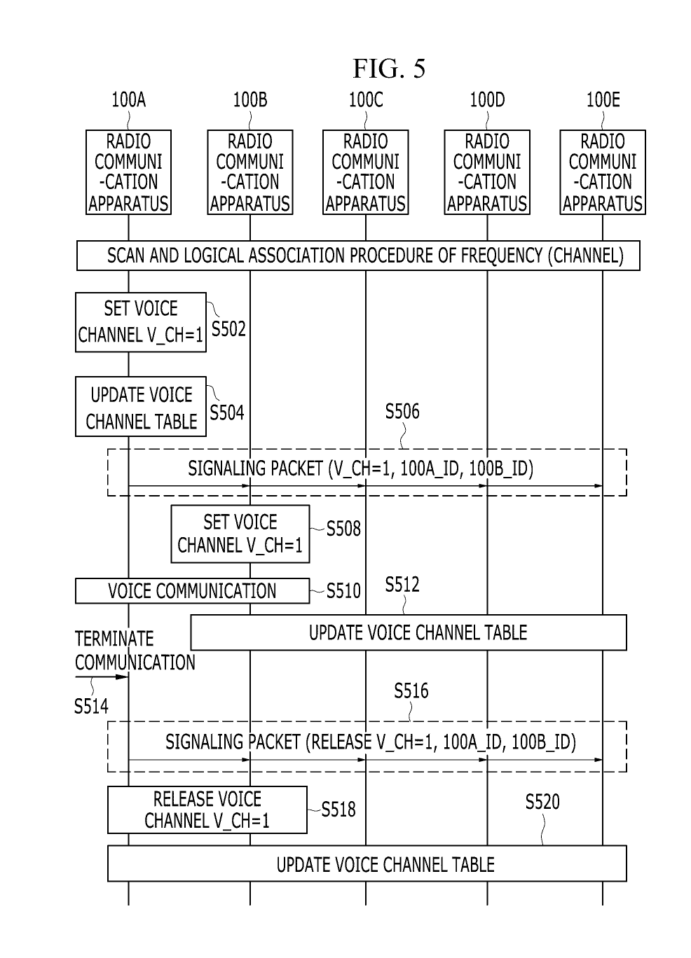

Hereinafter, a communication method of the complex communication apparatus 100 according to an exemplary embodiment of the present invention will be described in detail with reference to FIGS. 5 to 7.

FIGS. 5 to 7 illustrate a communication method of the complex communication apparatus 100 according to an exemplary embodiment of the present invention using five complex communication apparatuses 100a-100e of FIG. 1.

FIG. 5 is a diagram illustrating a one-to-one communication method of a complex communication apparatus according to an exemplary embodiment of the present invention.

Particularly, FIG. 5 is a diagram illustrating an operation procedure of complex communication apparatuses 100a-100e for one-to-one communication of the complex communication apparatuses 100a and 100b.

Referring to FIG. 5, before starting voice communication, the complex communication apparatuses 100a-100e perform a scan and logical association procedure of a network frequency (channel), thereby forming a multi-hop or single network. Further, before starting voice communication, the complex communication apparatuses 100a-100e set a communication group.

The complex communication apparatus 100a starting voice communication selects and sets a voice channel for voice communication with another complex communication apparatus 100b with reference to a voice channel table thereof (S502) and updates the voice channel table (S504). That is, when the complex communication apparatus 100a selects a voice channel V_ch=1, the complex communication apparatus 100a changes channel use T/F of the voice channel V_ch=1 to “T” in a voice channel table thereof and increases a channel use count of the voice channel V_ch=1 by 1.

Next, the complex communication apparatus 100a generates a signaling packet expressing information V_ch=1 of the set voice channel, a source identifier, and a destination identifier and broadcasts the signaling packet to the complex communication apparatuses 100b-100e (S506). The source identifier may be an identifier 100a_ID of the complex communication apparatus 100a that starts voice communication, and the destination identifier is an identifier of another party of voice communication and may be an identifier 100b_ID of another complex communication apparatus 100b to perform voice communication. The destination identifier represents a type of voice communication, and it is identified whether voice communication is one-to-one communication, group communication, or broadcast communication by the destination identifier. When the destination identifier is an identifier of a complex communication apparatus, the destination identifier represents one-to-one communication, and when the destination identifier is a group identifier, the destination identifier represents group communication.

The complex communication apparatuses 100b-100e, having received the broadcasted signaling packet determine whether a destination identifier within the signaling packet is an identifier in which the complex communication apparatuses 100b-100e have.

If a destination identifier within the signaling packet is an identifier of the complex communication apparatus 100b, the complex communication apparatus 100b sets a voice channel to communication to No. 1 according to the voice channel information V_ch=1 (S508). Thereafter, the complex communication apparatuses 100a and 100b that set the voice channel V_ch=1 perform voice communication through the bi-directional radio communication unit (109 of FIG. 1) (S510).

Further, the complex communication apparatus 100b updates a voice channel table thereof (S512). That is, the complex communication apparatus 100b changes channel use T/F of the voice channel V_ch=1 to “T” in a voice channel table thereof and increases a channel use count of the voice channel V_ch=1 by 1.

Further, the remaining complex communication apparatuses 100c-100e in which a destination identifier within the signaling packet is not an identifier thereof update voice channel tables thereof (S512). That is, the complex communication apparatuses 100c-100e change channel use T/F of a voice channel V_ch=1 to “T” according to voice channel information V_ch=1 of a signaling packet and display that the voice channel V_ch=1 is being used in voice channel tables thereof and increases a channel use count of the voice channel V_ch=1 by 1.

After one-to-one voice communication is performed between the complex communication apparatuses 100a and 100b, when communication is not performed between the complex communication apparatuses 100a and 100b for a predetermined time period or when communication is terminated by a user input (S514), the complex communication apparatus 100a generates a signaling packet representing use release of the voice channel V_ch=1 that is set to the complex communication apparatus 100a and 100b that participate in one-to-one voice communication and broadcasts the signaling packet to the complex communication apparatuses 100b-100e (S516).

The complex communication apparatuses 100a and 100b release the set voice channel V_ch=1 (S518). Further, the complex communication apparatus 100a and the complex communication apparatuses 100b-100e, having received the signaling packet change channel use information T/F of the voice channel V_ch=1 to “F” in respective voice channel tables thereof (S520).

In such one-to-one voice communication, a change of a voice channel may be also similarly performed through a signaling packet.

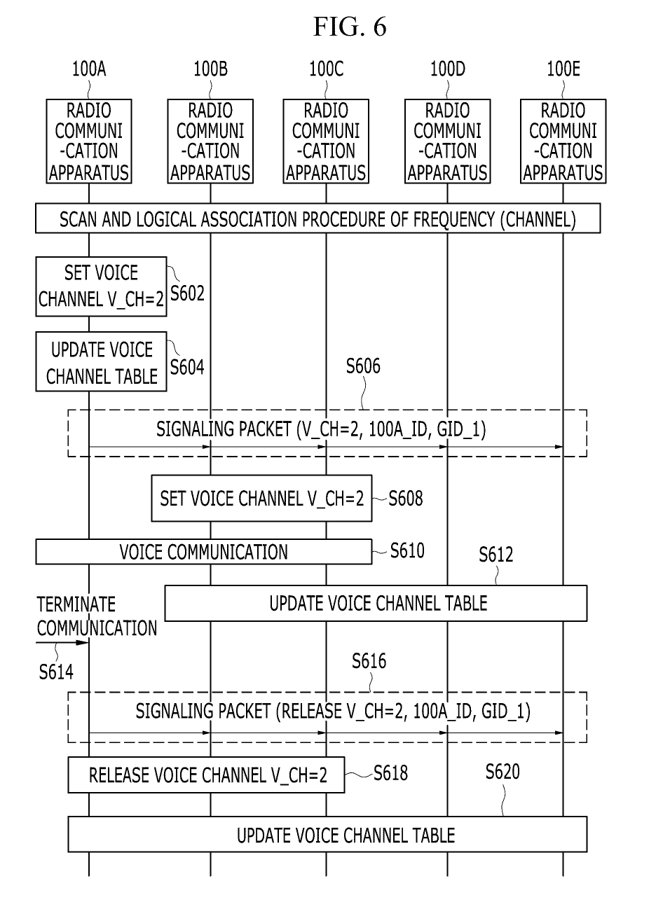

FIG. 6 is a message flow diagram illustrating a group communication method of a complex communication apparatus according to an exemplary embodiment of the present invention.

Particularly, FIG. 6 is a message flow diagram illustrating an operation procedure of complex communication apparatuses 100a-100e for group communication of the complex communication apparatuses 100a, 100b, and 100c.

Referring to FIG. 6, before starting voice communication, the complex communication apparatuses 100a-100e perform a scan and logical association procedure of a network frequency (channel), thereby forming a multi-hop or single network. Further, before starting voice communication, the complex communication apparatuses 100a-100e set a communication group.

The complex communication apparatus 100a starting voice group communication selects and sets a voice channel V_ch=2 for voice group communication with reference to a voice channel table thereof (S602).

The complex communication apparatus 100a changes channel use information T/F of a voice channel V_ch=2 to “T” in a voice channel table thereof and increases a channel use count of the voice channel V_ch=2 by 1 (S604).

Next, the complex communication apparatus 100a generates a signaling packet expressing information V_ch=2 of the set voice channel, a source identifier, and a destination identifier and broadcasts the signaling packet to the complex communication apparatuses 100b-100e (S606). The source identifier may be an identifier 100a_ID of the complex communication apparatus 100a that starts voice communication, and the destination identifier may be a group identifier GID_1. It is assumed that the complex communication apparatuses 100a-100c are a group that is set to a group identifier GID_1.

The complex communication apparatuses 100b-100e, having received a signaling packet determine whether a destination identifier of the signaling packet is an identifier in which the complex communication apparatuses 100b-100e have.

The complex communication apparatuses 100b and 100c having the group identifier GID_1 set a voice channel to communicate to No. 2 according to information V_ch=2 of respective voice channels thereof (S608). Thereafter, the complex communication apparatuses 100a-100c that set the voice channel V_ch=2 perform voice group communication through a bi-directional radio communication unit (S610).

The complex communication apparatuses 100b and 100c change channel use T/F of the voice channel V_ch=2 to “T” in respective voice channel tables thereof and increase a channel use count of the voice channel V_ch=2 by 1 (S612).

Further, the remaining complex communication apparatuses 100d and 100e having no group identifier GID_1 change channel use T/F of the voice channel V_ch=2 to “T” in respective voice channel tables thereof and increase a channel use count of the voice channel V_ch=2 by 1 (S612).

After group voice communication between the complex communication apparatuses 100a-100c is performed, when communication is not performed between the complex communication apparatuses 100a-100c for a predetermined time period or when communication is terminated by a user input (S614), the complex communication apparatus 100a generates a signaling packet representing use release of the voice channel V_ch=2 that is set to complex communication apparatuses 100a-100c that participate in group voice communication and broadcasts the signaling packet to the complex communication apparatuses 100b-100e (S616).

The complex communication apparatuses 100a and 100b release the set voice channel V_ch=2 (S618). Further, the complex communication apparatus 100a and the complex communication apparatuses 100b-100e, having received the signaling packet change channel use information T/F of the voice channel V_ch=2 to “F” in respective voice channel tables thereof (S620).

In such group voice communication, a change and release of a group may be also similarly performed through a signaling packet, and a change of a voice channel may be also similarly performed through a signaling packet.

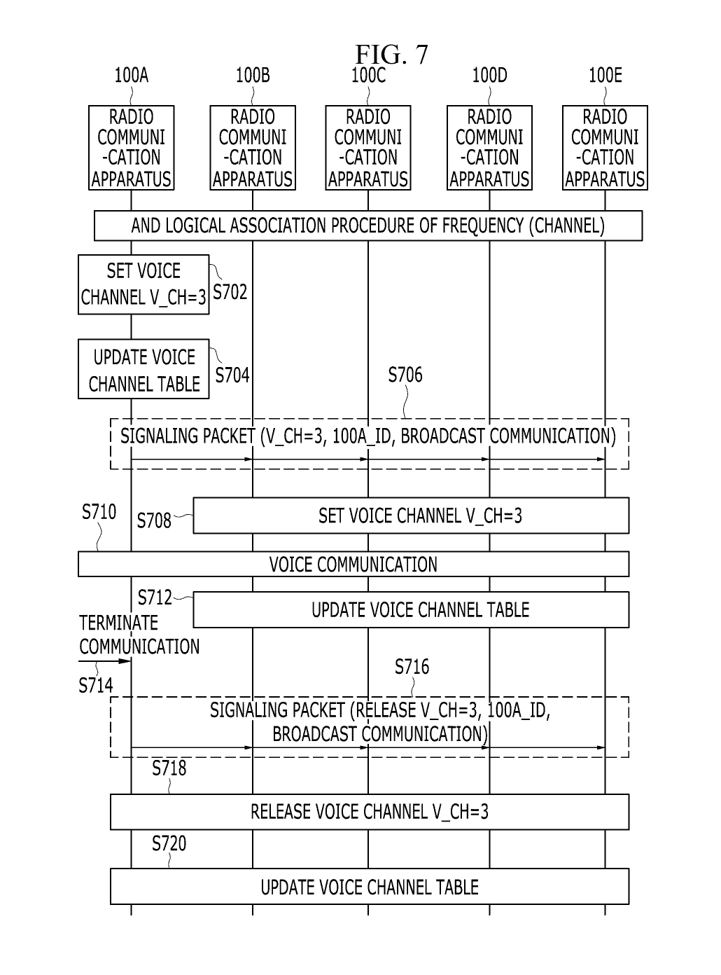

FIG. 7 is a message flow diagram illustrating a broadcast communication method of a complex communication apparatus according to an exemplary embodiment of the present invention. Referring to FIG. 7, before starting voice communication, the complex communication apparatuses 100a-100e perform a scan and logical association procedure of a network frequency (channel), thereby forming a multi-hop or single network. Further, before starting voice communication, the complex communication apparatuses 100a-100e set a communication group.

The complex communication apparatus 100a starting broadcast voice communication selects a voice channel V_ch=3 to communication with reference to a voice channel table thereof and sets a voice channel (S702).

The complex communication apparatus 100a changes channel use information T/F of a voice channel V_ch=3 to “T” in a voice channel table thereof and increases a channel use count of the voice channel V_ch=3 by 1 (S704).

Next, the complex communication apparatus 100a generates a signaling packet expressing information V_ch=3 of the set voice channel, a source identifier, and a destination identifier and broadcasts the signaling packet to the complex communication apparatuses 100b-100e (S706). The source identifier may be an identifier 100a_ID of the complex communication apparatus 100a that starts voice communication, and the destination identifier may be information representing broadcast communication. As an example, when all destination identifiers are set to 1, the destination identifiers may represent broadcast communication.

The complex communication apparatuses 100b-100e, having received the signaling packet determine a destination identifier of the signaling packet.

When the destination identifier of the signaling packet represents broadcast communication, all complex communication apparatuses 100b-100e set a voice channel to communication to No. 3 according to information V_ch=3 of respective voice channels thereof (S708). Thereafter, the complex communication apparatuses 100a-100e that set a voice channel V_ch=3 perform voice communication through the bi-directional radio communication unit (109 of FIG. 1) (S710).

The complex communication apparatuses 100b-100e change channel use T/F of the voice channel V_ch=3 to “T” in respective voice channel table thereof and increase a channel use count of the voice channel V_ch=3 by 1 (S712).

After broadcast voice communication is performed between the complex communication apparatuses 100a-100e, when communication is not performed between the complex communication apparatuses 100a-100e for a predetermined time period or when communication is terminated by a user input (S714), the complex communication apparatus 100a generates a signaling packet representing use release of the voice channel V_ch=3 that is set to broadcast voice communication and broadcasts the signaling packet to the complex communication apparatuses 100b-100e (S716).

The complex communication apparatuses 100a-100e release the set voice channel V_ch=3 (S718) and change channel use information T/F of the voice channel V_ch=3 to “F” in respective voice channel table thereof (S720).

Further, as shown in FIG. 5, while one-to-one voice communication is performed between the complex communication apparatuses 100a and 100b, one-to-one voice communication between other complex communication apparatuses (e.g., 100d, 100e) or group voice communication between other complex communication apparatuses (e.g., 100c-100e) can be performed not to collide with a corresponding signaling packet.

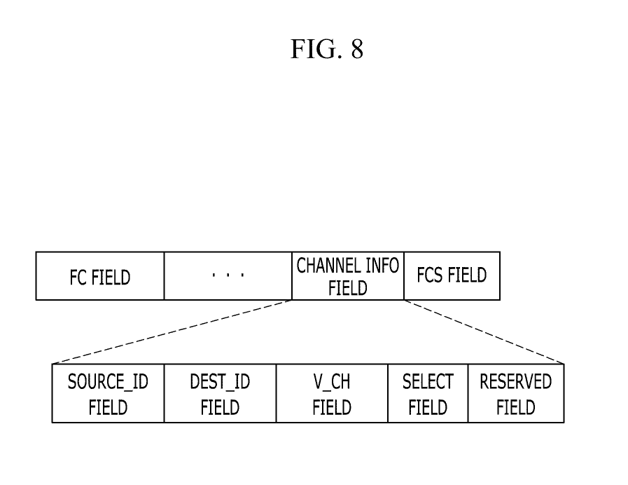

FIG. 8 is a block diagram illustrating a signaling packet structure according to an exemplary embodiment of the present invention.

Referring to FIG. 8, a signaling packet includes a frame control (FC) field, a channel information (channel info) field, and a frame check sequence (FCS) field.

The FC field represents a packet kind and control information. The FC field may include bit information representing a kind of a packet. It can be seen whether a corresponding signaling packet is a beacon, a data packet, or an acknowledgment packet through the bit information.

The channel info field has a size of 4 bytes and includes a source identifier (Source_ID) field, a destination identifier (Dest_ID) field, a voice channel (V_ch) field, a Select field, and a Reserved field. The Source_ID field includes an identifier of a complex communication apparatus that starts communication. The Dest_ID field represents a type of communication and includes one of an identifier of a complex communication apparatus of another party of communication, a group identifier, and a broadcast communication identifier. The Source_ID field and the Dest_ID field may have a size of 8 bits. In the Source_ID field and the Dest_ID field, when a most significant bit (MSB) of 8 bits is 0, the identifier is an identifier of a complex communication apparatus, and when a most significant bit (MSB) of 8 bits is 1, the identifier is a group identifier. For example, “0000 0001” represents a complex communication apparatus in which an identifier is 1, and “1000 0001” represents a group identifier 1. Further, in the Dest_ID field, when all 8 bits are 1, the identifier field represents a broadcast communication identifier.

The V_ch field includes a voice channel number that is set in voice communication and has a size of 8 bits.

The Select field includes use of a voice channel number that is included in the V_ch field and has a size of 1 bit.

For example, in a signaling packet that is broadcasted at step S506 of FIG. 5, V_ch=1 is set at the V_ch field, and “T” representing use of V_ch=1 is set at the Select field. Further, in a signaling packet that is broadcasted at step S516 of FIG. 5, V_ch=1 is set at the V_ch field, and “F” representing release of V_ch=1 is set at the Select field.

The Reserved field is a field that is not presently used and is a field that is reserved for using later. The Reserved field may have a size of 7 bits.

The FCS field is a field for checking an error of a packet at the receiving side and includes a value that is calculated by a check equation at the transmitting side.

According to an exemplary embodiment of the present invention, in a complex communication apparatus, packet communication can be performed using a physical channel of a WPAN as a signaling channel, and setting of a random group and setting and change of a channel for voice communication can be performed through packet communication.

Further, the complex communication apparatus can sense and provide object or peripheral information in addition to voice communication, thereby improving a utility value.

An exemplary embodiment of the present invention may be not only embodied through the above-described apparatus and/or method but also embodied through a program that executes a function corresponding to a configuration of the exemplary embodiment of the present invention or through a recording medium on which the program is recorded and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of communicating in a complex communication apparatus, the method comprising:
setting one voice channel of available voice channels for voice communication;
broadcasting a signaling packet expressing a destination identifier representing a type of voice communication and information of the one voice channel; and
performing voice communication with at least one complex communication apparatus corresponding to a destination identifier of a plurality of other complex communication apparatuses, having received the signaling packet.

2. The method of claim 1, wherein the broadcasting of a signaling packet comprises broadcasting the signaling packet through a physical channel of a wireless personal area network.

3. The method of claim 2, further comprising sensing peripheral information and transmitting the peripheral information to the outside through the physical channel.

4. The method of claim 1, wherein the type of the voice communication comprises at least one-to-one communication, group communication, and broadcast communication.

5. The method of claim 3, wherein the destination identifier is comprised in a destination identifier field of the signaling packet, and
a most significant bit of the destination identifier field represents one of the one-to-one communication, the group communication, and the broadcast communication.

6. The method of claim 5, wherein when all bits of the destination identifier field are 1, the identifier field represents the broadcast communication.

7. The method of claim 1, further comprising displaying that the one voice channel is being used in a voice channel table in which information of available voice channels is stored.

8. The method of claim 7, further comprising increasing a channel use count of the one voice channel by 1 in the voice channel table.

9. The method of claim 8, wherein the setting of one of available voice channels comprises selecting a voice channel that is not used and that has a small channel use count as the one voice channel with reference to the voice channel table.

10. A method of communicating in a complex communication apparatus, the method comprising:
receiving a signaling packet comprising a destination identifier field representing a destination identifier and a voice channel field representing voice channel information from other complex communication apparatuses;
setting, when the destination identifier corresponds with an identifier in which the complex communication apparatus has or when the destination identifier represents broadcast communication, a voice channel according to the voice channel information; and
performing voice communication with the other complex communication apparatuses through the voice channel.

11. The method of claim 10, wherein the receiving of a signaling packet comprises receiving the signaling packet through a physical channel of a wireless personal area network.

12. The method of claim 11, further comprising sensing peripheral information and transmitting the peripheral information to the outside through the physical channel.

13. The method of claim 10, wherein an identifier in which the complex communication apparatus has comprises an identifier of the complex communication complex communication apparatus and an identifier of a group comprising the complex communication apparatus, and
the destination identifier represents an identifier of the apparatus or an identifier of the group according to a most significant bit of the destination identifier field.

14. The method of claim 10, wherein the setting of a voice channel comprises determining, when all bit values of the destination identifier field are 1, that voice communication is the broadcast communication.

15. The method of claim 10, wherein the setting of a voice channel comprises
displaying that the set voice channel is being used in a voice channel table in which information of available voice channels is stored; and
increasing a channel use count of the set voice channel by 1 in the voice channel table.

16. The method of claim 10, further comprising:
displaying, when the destination identifier does not correspond with an identifier in which the complex communication apparatus has and does not represent broadcast communication, that a voice channel corresponding to the voice channel information is being used in a voice channel table in which information of available voice channels is stored; and
increasing a channel use count of a voice channel corresponding to the voice channel information by 1 in the voice channel table.

17. A complex communication apparatus that performs voice communication, the complex communication apparatus comprising:
a wireless personal area network (WPAN) communication unit that transmits/receives a packet through a physical channel of a WPAN;
a bi-directional radio communication unit that transmits/receives voice information through a set voice channel; and
a controller that sets a voice channel to perform voice communication and that expresses a destination identifier representing a type of the voice communication and information of the set voice channel in a signaling packet and that broadcasts the signaling packet through the WPAN communication unit, when starting voice communication.

18. The complex communication apparatus of claim 17, further comprising a sensor unit that senses peripheral information or that receives sensing information from another sensor and that transmits the sensing information to the outside through the physical channel.

19. The complex communication apparatus of claim 17, wherein the controller sets a voice channel corresponding to the voice channel information according to a destination identifier of the signaling packet, when receiving a signaling packet from other complex communication apparatuses through the WPAN communication unit.

20. The complex communication apparatus of claim 17, wherein the destination identifier represents one of an identifier of the complex communication apparatus, a group identifier, and broadcast communication.
